(19) United States
(12) Patent Application Publication
(10) Pub. No.: US 2003/0046239 A1
(43) Pub. Date: Mar. 6, 2003

(54) Content management and distribution

(76) Inventors: Brad Geilfuss, New york, NY (US); Essam Abadir, New York, NY (US); Jack Geilfuss, North Bergen, NJ (US); Giuseppe Ciaramitaro, Brooklyn, NY (US); Jamie Cho, North Bergen, NJ (US); Ben Bernard, Cliff Island, ME (US)

Correspondence Address: FISH & RICHARDSON PC, 225 FRANKLIN ST, BOSTON, MA, 02110, US

(21) Appl. No.: 09/943,400

(22) Filed: Aug. 30, 2001

(51) Int. Cl. G06F 17/60

(52) U.S. Cl. 705/51

(57) ABSTRACT

A method includes maintaining in a first server unique references to content received from primary servers, maintaining an index containing the unique references to the content, and notifying a secondary server when updated content has been added to the server.

### TECHNICAL FIELD

This invention relates to content management and distribution.

### BACKGROUND

Content, sometimes referred to as digital assets, resides on systems that are inter-connected by a globally connected network such as an internet. Content includes images, video, audio, text documents, metadata, software, electronic books, Hyper-Text Markup Language (HTML), Extensible Markup Language (XML) and services.

Content aggregators, e.g., web servers operated by hosts such as Amazon.com, receive content in bulk electronically from content originators. Content aggregators deliver content to users in response to user requests.

For example, when a user clicks on the name of a book on an Amazon.com web page that appears on his browser, the request may trigger a response in the form of a new web page that is generated at the Amazon.com web server and contains an image of the book cover (i.e., content). The content originator may be a book publisher that supplies bulk updated sets of images of book covers to the Amazon.com web server periodically

### SUMMARY

According to one aspect of the invention, a method includes maintaining in a first server unique references to content received from primary servers, maintaining an index containing the unique references to the content, and notifying a secondary server when updated content has been added to the first server.

One or more of the following features may also be included. The method may include notifying the secondary server when content has expired. The unique references may refer to local content. The unique references may refer to pointers to content. The method may also include passing one of the unique references to the secondary server for use in fetching the content. The secondary server may manage its cache size in relationship to fetched content or metadata. The method may also include fetching the content in the secondary server, and checking a size of the fetched content with a size of the cache containing current content in the secondary server. The secondary server may manage it cache size in relationship to previously fetched content or metadata. Passing may include copying content identified by the unique reference to the secondary server. The method may also include checking the secondary server to determine whether the content is already present. Passing may also include copying metadata associated with the content identified by the unique reference to the secondary server.

The method may also include delivering the copied content to a user system. The method may include receiving a user request and effecting the delivering in response to the user request. Passing may further include verifying that the secondary server is authorized to receive content. Passing may further include updating a tracking file that reflects a user request for content. Passing may include updating a tracking file that reflects maintaining and notifying.

The secondary server may maintain the index. The secondary server may notify a tertiary server when content expires. The secondary server may pass one of the unique references to the tertiary server. The secondary server may verify that the tertiary server is authorized to receive content. The secondary server may maintain and update a tracking file that reflects actions performed with the index.

According to another aspect of the invention, a method includes maintaining a store of content received from primary servers in a first server, maintaining an index containing unique references to the content residing in the store, receiving a user request for content at a secondary server, passing a unique reference associated with the user requested content to the secondary server, and copying the content associated with the unique reference from the store to the secondary server.

One or more of the following features may also be included. The secondary server may manage its cache size in relationship to fetched content. The method may also include fetching the content in the secondary server, and checking a size of the fetched content with a size of the cache containing current content in the secondary server. The method may include notifying the secondary server when content has expired. The method may also include delivering the user requested content from the secondary server to a user system. Passing may include verifying whether the secondary server is authorized to receive the unique reference. The method may also include accumulating data that represents tracking user requests for content. The method may also include accumulating data that represents tracking the maintaining, receiving, passing and copying. The method may also include analyzing the data in response to requests from the primary servers, and generating reports from the analyzed data. The method may also include analyzing the data in response to requests from the primary servers, and generating reports from the analyzed data. The secondary server may maintain the index and may notify a tertiary server when content expires. The secondary server may also pass one of the unique references to the tertiary server and may verify that the tertiary server is authorized to receive content. The secondary server may maintain and update a tracking file that reflects actions performed with the index.

According to another aspect of the invention, a system includes a plurality of content origination servers linked to a first server, a plurality of servers linked to the first server, the first server including a store for maintaining and distributing content received from the primary servers, means for maintaining an index of unique identifiers associated with the stored content, means for passing one of the unique identifiers to one of the servers, and means for delivering the content associated with a unique identifier to the server.

One or more of the following features may also be included. The system may include means for notifying the server when content has expired. The means for passing may also include a means for authenticating that the server is authorized to receive the unique identifier. The system may also include means for notifying the server when content associated with a unique identifier is updated.

According to another aspect of the invention, a method includes on a server, storing content that has been requested by a previous user and has not expired, serving the unexpired, previously requested content from the web server to a current user in response to a request, if the current user requests content that is not stored on the web server, obtaining the content from a central location and storing it in the server for use in responding to later user requests, and removing expired content from the web server.

One or more of the following features may also be included. The method may include informing the server when content has expired. The method may also include on the server, communicating with a remote process on a remote server, the remote process caching content.

According to another aspect of the invention, a method includes maintaining in a first server unique references to content received from primary servers and notifying a secondary server when content has expired.

One or more of the following features may also be included. The method may also include notifying the secondary server when updated content has been added to the first server. The method may also include maintaining an index containing the unique references to the content. The unique references may refer to local content. The unique references may refer to pointers to content. The method may also include passing one of the unique references to the secondary server for use in fetching the content. The secondary server may manage its cache size in relationship to fetched content or metadata. The method may include fetching the content in the secondary server, and checking a size of the fetched content with a size of the cache containing current content in the secondary server. The secondary server may manage its cache size in relationship to previously fetched content or metadata. Passing may also include copying content identified by the unique reference to the secondary server. The method may also include checking the secondary server to determine whether the content is already present. Passing may also include copying metadata associated with the content identified by the unique reference to the secondary server. The method may also include delivering the copied content to a user system. The method may also include receiving a user request and effecting a delivering in response to the user request. Passing may include verifying that the secondary server is authorized to receive content. Passing may include updating a tracking file that reflects a user request for content. Passing may also include updating a tracking file that reflects maintaining and notifying. The secondary server may maintain the index and notify a tertiary server when content expires. The secondary server may also pass one of the unique references to the tertiary server and may verify that the tertiary server is authorized to receive content. The secondary server may maintain and update a tracking file that reflects actions performed with the index.

Embodiments of the invention may have one or more of the following advantages.

The content management and distribution system synergizes the technologies of distributed computing and caching.

The system enables a just-in-time network of business critical information providing users with the information they need when they need it. The just-in-time network is a network where the updated information is pulled all the way from the originator to the local server to the end user.

The system enables an electronic business (e-Business) to dramatically reduce bandwidth, storage, and computing costs to internetwork a content management system with multiple portals.

An e-Business can navigate multi-gigabytes of data and network highly distributed content.

Relevant content can be delivered to the users.

Authoritative ownership of information can be maintained real-time updates integrated.

Content is accessed and exchanged in a secure manner.

Content can be considered stored in a virtual inventory thus minimalizing costs via a just-in-time-transfer. Data is “fresh” and updated content is immediately available.

A content server is notified when an item of content has become “stale.” Delivering “updated” content from a content server to a website server is done only when a user of the website server requests the content.

The system may present a peer-to-peer network.

Other advantages and features will become apparent from the following description and from the claims.

### DESCRIPTION OF DRAWINGS

FIG. 1 shows a content distribution and management network.

FIGS. 2 and 3 show content distribution and management processes.

### DETAILED DESCRIPTION

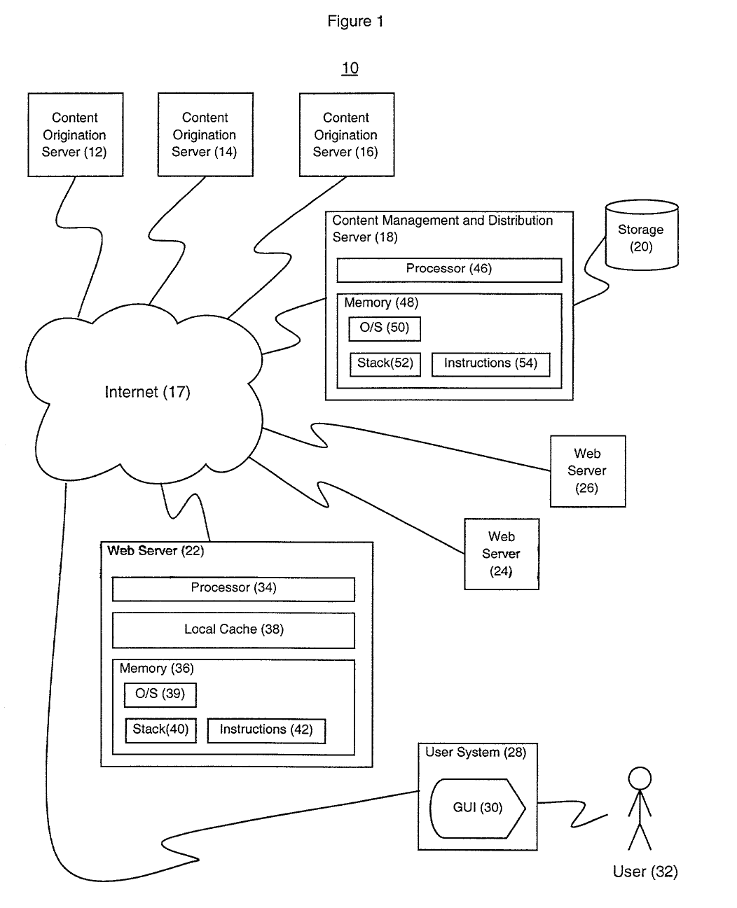

Referring to FIG. 1, a content management and distribution network 10 includes, for example, content origination servers 12, 14 and 16 (also referred to as primary servers) linked to the Internet 17. A content management and distribution server 18 is also shown linked to the Internet 17. Each of the content origination servers 12, 14, and 16 stores and makes available original versions of content or references to original content that is to be distributed through the Internet 17 and server 18 to users 32 of user systems 28. Content is considered a digital asset and includes, for example, images, video, audio, text documents, software, electronic books, Hyper-Text Markup Language (HTML), Extended Markup Language (XML), software and services. Content and/or references to content is generated by content originators and stored in each of the content origination servers 12, 14 and 16. A single content management and distribution server 18 is shown in FIG. 1, but there could be additional distributed content management and distribution servers, like content management and distribution server 18.

The content management and distribution server 18 may include a local storage device 20 and is accessed through the Internet 17 by, for example, web servers 22, 24 and 26, and/or other servers (not shown). Each of the web servers 22, 24 and 26 serves user systems through the Internet 17.

For example, web server 22 can serve user system 28 through the Internet 17. The user system 28 may include a graphical user interface (GUI) 30 that displays a web browser (not shown), such as Microsoft's Internet Explorer or AOL's Netscape Navigator, to a user 32. Although only one web server 22 is shown as serving user 32 by way of example, additional servers, like web server 24 and web server 26 or other types of servers, such as, for example, a streaming video server, can serve user 32 and other users (not shown).

Each of the web servers, web server 22 for example, contains, for example, a processor 34, a memory 36 and a local cache 38. The web server typically manages the size of its local cache 38 in relationship to fetched content, for example, by checking the local cache size of fetched content with a size of the local cache containing current content. Thus, managing may include removing content from the cache or expanding the size of the cache. Memory 36 stores an operating system (“OS”) 39 such as Windows98® or Linux, a TCP/IP protocol stack 40 for communicating with the Internet 17, and machine-executable instructions 42 executed by processor 34 to perform a site request process 64, described below.

Like each of the web servers described above, the content management and distribution server 18 contains, for example, a processor 46 and a memory 48. Memory 48 stores an operating system (“OS”) 50 such as Windows98® or Linux, a TCP/IP protocol stack 52 for communicating with the Internet 17. The memory 48 also stores machine-executable instructions 54 executed by processor 46 to perform a content management and distribution process 56, described below. Other types of computing systems not having the specific elements described may also be used in other examples.

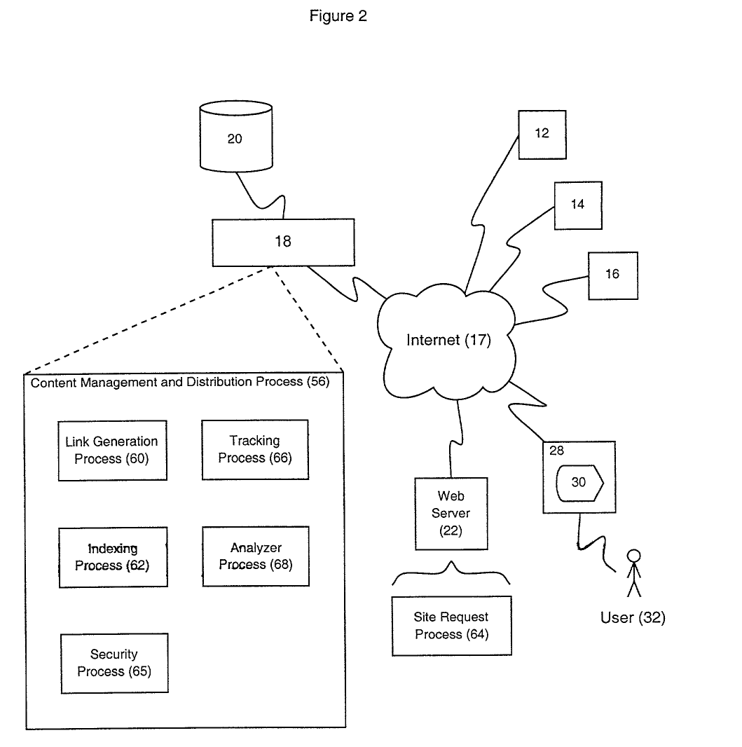

Referring to FIG. 2, the content management and distribution process 56 receives content and/or references to content, along with meta data, such as a time stamp, from time to time from one or more of the content originator servers 12, 14 and 16. The received content and/or references to content are stored in local storage device 20. The content management and distribution process 56 includes a link generation process 60. When content and/or references to content is received and stored in local storage device 20, the link generation process 60 generates a unique reference that is used to refer to the location of the content where it can be found on the local storage device 20, or to the pointer where content may be found internal or external to the content management and distribution network 10. The unique reference represents a unique descriptor. The unique descriptor may be a filename, pointer, Universal Resource Locator (URL), and so forth. For example, the unique reference may lead to an image of a certain book cover originated from a content origination server. The unique reference may look like, for example, the following:

/liquidrelay/organization/user/project/resourcename.doc.

The content management and distribution process 56 also includes an indexing process 62. To quickly locate content that may be stored on a potentially large number of content and management distribution servers, the indexing process 62 is responsible for knowing where that content is located on the various content and management distribution servers. The indexing process 62 maintains an index of the unique references generated by the link generation process 60, along with metadata, such as a time stamp representing the date and time that the content was received by the content management and distribution server 18. The index may be contained in any suitable data structure, such as an array or binary tree.

In some implementations, content and/or references to content are stored on more than one local storage device 20 connected to the content management and distribution server 18 or to the Internet 17. In other examples, content is stored in multiple distributed content management and distribution servers.

Although content and/or references to content stored on the content management and distribution servers is available to the web servers 22, 24 and 26, the content and/or references to content may not been distributed yet, e.g., the content remains stored in the local storage device 20.

The user 32 browsing one of the web servers, web server 22 for example, may submit a request for content to the web server 22. Each of the web servers includes a site request process 64. The site request process 64 handles resource caching and expiration and returns tracking information to a tracking process 66 described below.

The site request process 64 receives the user request for content and determines whether the requested content is contained in the local cache 38. The requested content may be in the local cache 38 if it had been previously requested by the user 32 or by another user (not shown). If the requested content is present in the local cache 38, the requested content is delivered to the user system 28 from the local cache 38 and displayed to the user 32 on the GUI 30.

If the requested content is not present in the local cache 38, the site request process 64 sends a request for the content to the content management and distribution server 18. A security process 65 receives the user request for content. The security process 65 oversees the security of the content server and distribution network 10. In an example, security process 65 determines whether the requesting web server, web server 22 for example, is authorized for delivery of the requested content from the local storage device 20. This is referred to as content security. Content security is required to ensure that any content requested by a web server has been authorized for delivery to that web server and that the requesting web server accepts content from the owning organization, i.e., one of the content origination servers 12, 14 and 16. In an example, the content management and distribution server 18 maintains a registry such as, for instance, a database (not shown). The registry contains a list of authorizing conditions.

Content security is one of the conditions maintained by the security process 65. Other conditions maintained by the security process 65 are referred to as service security conditions.

The indexing process 62, the security process 65, the tracking process 66, and the analyzer process 68 are all considered services with the content management and distribution process 56. The security process 65 ensures service security, i.e., that the services necessary in keeping the content management and distribution network 10 functional are legitimate and also that the services are authorized to be used by a particular organization.

For example, if an unauthorized system, internal or external to the content management and distribution network 10, presents itself as containing an indexing process, the security process 65 ensures that requests from the unauthorized indexing process are not permitted to copy content and/or references to content from the content management and distribution network 10.

In another example, the security process 65 prevents an unauthorized system having its own security process from obtaining information from security process 65 or the registry.

If the security process 65 determines that the web server 22 has authority to deliver the requested content, the security process 65 passes the request for content to the indexing process 62. The index process 62 matches the request for content with its unique reference and sends the unique reference to the web server 22. The web server 22 uses the received unique reference to copy the content from storage 20 to the local cache 38 of the web server 22. The web server 22 delivers the received and requested content to the user 32 through the GUI 30 of the user system 28.

In a variation of the above content management and distribution process 56, the indexing process 62, the security process 65, the tracking process 66 and analyzer process 68 may reside outside of the content management and distribution server 18 on separate servers (not shown) connected to the content management and distribution server 18 or the Internet 17.

The content management and distribution process 56 also includes the tracking process 66. The tracking process 66 is responsible for data gathering. This data is received from the site request process 64 and reflects, for example, tracking information from users accessing content on the web server 22. More specifically, the tracking process 66 keeps tallies of how often content is requested, by/from/through whom they are requested and, if desired, how long the content is used by the user 32.

The tracking process 66 also gathers data representative of when the various services, e.g., link generation process 60, indexing process 62, site request process 64, security process 65 and analyzer process 68, interact with each other. For example, the tracking process 66 keeps track of how often the security process 65 is being used by the indexing process 60. This service data is generated by the processes 60, 62, 64 and 65 each time they are accessed, e.g., at the time each of the processes are accessed they send an access notification to the tracking process 66.

The data that is gathered by the tracking process 66 interfaces with an analyzer process 68. The analyzer process 68 periodically or in response to a request from, for example, content origination server 12, interprets and forwards the gathered data to the origination server 12 or to some other authorized server (not shown) in the network 10.

When one or more of the content origination servers updates their content, they send the updated content to the content management and distribution server 18. More specifically, the updated content is received by the link generation process 60 and stored in the local storage device 20. The link generation process 60 realigns the unique identifier for the content and a message to expire is sent to the site request process 64 of each of the web servers, e.g., web server 22. The message to expire instructs the web server 22 to check it's local cache 38, and if the original content that is being replaced by the updated content is present in the web server 22, then to flush its local cache 38. In this way, subsequent user requests for the content are delivered the most updated content generated from the content origination server 12.

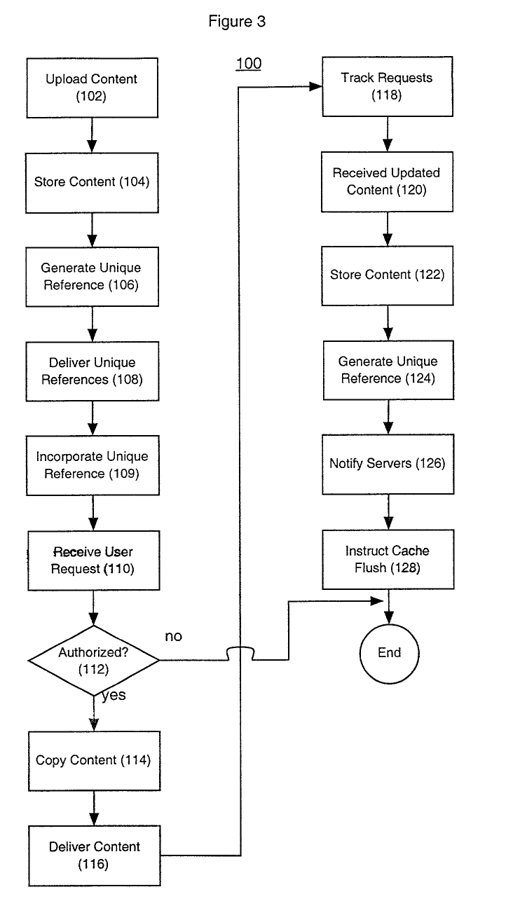

Referring to FIG. 3, a process 100 for content management and distribution includes uploading 102 content or a reference to content from a content origination server to a content management and distribution server. The process 100 includes storing 104 the content and associating 106 a unique reference to the location 108 in which the content has been stored in an index. The process 100 delivers 108 the unique reference to a server. The process 100 incorporates 109 the unique reference for the requested content. The process 100 receives 110 a user request for content in a web server. The process 100 determines 112 if the web server is authorized to access the requested content. If the web server is authorized to access the requested content, the process 100 copies 114 the requested content from the local storage to a local cache of the web server using the unique reference. The process 100 delivers 116 the content from the local cache to the user.

The process 100 tracks 118 the content requested and stores 118 the information in a tracking file. The process 100 periodically receives 120 updated content from the content origination server. The updated content is stored 122, for example, in the local storage. A link is realigned 124 for the updated content and the link maintained 126 in the index. The process 100 notifies 128 the web server that updated content is available and instructs 130 the web server to flush 132 is local cache of the original content, if present.

Processes 56 and 64 save bandwidth and processing time by reducing the costs associated with transferring digital assets between the content management and distribution system 18 and web servers 22, 24 and 26. Processes 56 and 64 accomplish this savings, for example, by maintaining an inventory of current updated content in one or more central locations and delivering content on a “just-in-time” basis in response to a user request for the content. That is, updated content is only copied to the web servers 22, 24 and 26 when a user makes a request for the content. In this manner, content is stored in a virtual inventory rather than in each of the individual web servers 22, 24 and 26, where it can become outdated when new content becomes available.

Processes 56 and 64 and the notion of a virtual “just-in-time” inventory of content may be illustrated by way of example using http://www.amazon.com (“amazon.com”).

Amazon.com is an on-line retailer of, among others things, books. Descriptive information relating to the sale of books may come from any number of publishers. Any of the descriptive information may change over time, such as the cover of a book. This change may come from amazon.com or one of the publishers. Amazon.com maintains an inventory of content on a server that includes hundred's of books. Amazon.com makes its web page content, i.e., books, available to users on the Internet from its content origination server. Using processes 56 and 64 above, amazon.com or one of the publishers sends copies of its content to the content management and distribution server 18. Links are generated to refer to the start of the content received, the descriptive text and associated image. The received content is stored, for example, on the local storage device 20.

When a user 32 requests amazon.com content through one of the web servers, web server 22, for example, the content management and distribution server 18 sends the unique reference of the requested content to the web server 22, assuming web server 22 is authorized to receive such links. Using the unique reference, web server 22 copies the associated content to its local cache 38 and assembles the web page, i.e., generates the text and associated image, for display to the user 32.

When Amazon.com sends updated content, such as a new book cover image to display, to the server 18, the server 18 generates new links to the image and notifies the web servers, such as web server 22, that the original content has expired and new content is available, i.e. a new image. The web server 22 flushes its local cache 38 and loads new content into its local cache 38 if a new user request for the content is received. Thus, the user 32 has received “just-in-time” content.

Processes 56 and 64 are not limited to use with the hardware/software configuration of FIG. 1; they may find applicability in any computing or processing environment. Processes 56 and 64 may be implemented in hardware (e.g., an ASIC {Application-Specific Integrated Circuit} and/or an FPGA {Field Programmable Gate Array}), software, or a combination of hardware and software.

Processes 56 and 64 may be implemented using one or more computer programs executing on programmable computers that each include a processor, a storage medium readable by the processor (including volatile and non-volatile memory and/or storage elements), at least one input device, and one or more output devices.

Each such program may be implemented in a high level procedural or object-oriented programming language to communicate with a computer system. Also, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to perform processes 56 and 64.

Processes 56 and 64 may also be implemented as a computer-readable storage medium, configured with a computer program, where, upon execution, instructions in the computer program cause the computer to operate in accordance with processes 56 and 64.

Other implementations are within the scope of the following claims.

What is claimed is:

1. A method comprising:
maintaining in a first server unique references to content received from primary servers;
maintaining an index containing the unique references to the content; and
notifying a secondary server when updated content has been added to the first server.

2. The method of claim 1 further comprising notifying the secondary server when content has expired.

3. The method of claim 1 wherein the unique references refer to local content.

4. The method of claim 1 wherein the unique references refer to pointers to content.

5. The method of claim 1 further including passing one of the unique references to the secondary server for use in fetching the content.

6. The method of claim 5 wherein the secondary server manages its cache size in relationship to fetched content or metadata.

7. The method of claim 6 further comprising:
fetching the content in the secondary server; and
checking a size of the fetched content with a size of the cache containing current content in the secondary server.

8. The method of claim 5 wherein the secondary server manages its cache size in relationship to previously fetched content or metadata.

9. The method of claim 5 wherein passing further comprises copying content identified by the unique reference to the secondary server.

10. The method of claim 9 further comprising checking the secondary server to determine whether the content is already present.

11. The method of claim 9 wherein passing further comprises copying metadata associated with the content identified by the unique reference to the secondary server.

12. The method of claim 1 further comprising delivering the copied content to a user system.

13. The method of claim 1 further comprising receiving a user request and effecting the delivering in response to the user request.

14. The method of claim 5 wherein passing further comprises verifying that the secondary server is authorized to receive content.

15. The method of claim 5 wherein passing further comprises updating a tracking file that reflects a user request for content.

16. The method of claim 5 wherein the passing further comprises updating a tracking file that reflects maintaining and notifying.

17. The method of claim 1 wherein the secondary server maintains the index.

18. The method of claim 17 wherein the secondary server notifies a tertiary server when content expires.

19. The method of claim 18 wherein the secondary server passes one of the unique references to the tertiary server.

20. The method of claim 19 wherein the secondary server verifies that the tertiary server is authorized to receive content.

21. The method of claim 19 wherein the secondary server maintains and updates a tracking file that reflects actions performed with the index.

22. A computer program product residing on a computer readable medium having instructions stored thereon which, when executed by the processor, cause the processor to:
maintain in a first server unique references to content received from primary servers;
maintain an index containing the unique references to the content; and
notify a secondary server when updated content has been added to the first server.

23. The computer program product of claim 22 wherein the computer readable medium comprises a random access memory (RAM).

24. The computer program product of claim 22 wherein the computer readable medium comprises read only memory (ROM).

25. The computer program product of claim 22 wherein the computer readable medium comprises a hard disk drive.

26. A processor and a memory configured to:
maintain in a first server unique references to content received from primary servers;
maintain an index containing the unique references to the content; and
notify a secondary server when updated content has been added to the first server.

27. A method comprising:
maintaining a store of content received from primary servers in a first server;
maintaining an index containing unique references to the content residing in the store;
receiving a user request for content at a secondary server;
passing a unique reference associated with the user requested content to the secondary server; and
copying the content associated with the unique reference from the store to the secondary server.

28. The method of claim 27 wherein the secondary server manages its cache size in relationship to fetched content.

29. The method of claim 28 further comprising:
fetching the content in the secondary server; and
checking a size of the fetched content with a size of the cache containing current content in the secondary server.

30. The method of claim 27 further comprising notifying the secondary server when content has expired.

31. The method of claim 27 further comprising delivering the user requested content from the secondary server to a user system.

32. The method of claim 27 wherein passing further comprises verifying whether the secondary server is authorized to receive the unique reference.

33. The method of claim 27 further comprising accumulating data that represents tracking user requests for content.

34. The method of claim 27 further comprising accumulating data that represents tracking the maintaining, receiving, passing and copying.

35. The method of claim 33 further comprising:
analyzing the data in response to requests from the primary servers; and
generating reports from the analyzed data.

36. The method of claim 34 further comprising:
analyzing the data in response to requests from the primary servers; and
generating reports from the analyzed data.

37. The method of claim 27 wherein the secondary server maintains the index.

38. The method of claim 37 wherein the secondary server notifies a tertiary server when content expires.

39. The method of claim 38 wherein the secondary server passes one of the unique references to the tertiary server.

40. The method of claim 39 wherein the secondary server verifies that the tertiary server is authorized to receive content.

41. The method of claim 39 wherein the secondary server maintains and updates a tracking file that reflects actions performed with the index.

42. A computer program product residing on a computer readable medium having instructions stored thereon which, when executed by the processor, cause the processor to:
maintain a store of content received from primary servers in a first server;
maintain an index containing unique references to the content residing in the store;
receive a user request for content at a secondary server;
pass a unique reference associated with the user requested content to the secondary server; and
copy the content associated with the unique reference from the store to the secondary server.

43. A processor and a memory configured to:
maintain a store of content received from primary servers in a first server;
maintain an index containing unique references to the content residing in the store;
receive a user request for content at a secondary server;
pass a unique reference associated with the user requested content to the secondary server; and
copy the content associated with the unique reference from the store to the secondary server.

44. A system comprising:
a plurality of content origination servers linked to a first server;
a plurality of servers linked to the first server, the first server comprising:
a store for maintaining and distributing content received from the primary servers;
means for maintaining an index of unique identifiers associated with the stored content;
means for passing one of the unique identifiers to one of the servers; and
means for delivering the content associated with a unique identifier to the server.

45. The system of claim 44 further comprising means for notifying the server when content has expired.

46. The system of claim 44 where the means for passing also comprises a means for authenticating that the server is authorized to received the unique identifier.

47. The system of claim 44 also comprising means for notifying the server when content associated with a unique identifier is updated.

48. A method comprising:
on a server, storing content that has been requested by a previous user and has not expired,
serving the unexpired, previously requested content from the web server to a current user in response to a request,
if the current user requests content that is not stored on the web server, obtaining the content from a central location and storing it in the server for use in responding to later user requests, and
removing expired content from the web server.

49. The method of claim 48 also comprising informing the server when content has expired.

50. The method of claim 48 further comprising on the server, communicating with a remote process on a remote server, the remote process caching content.

51. A method comprising:
maintaining in a first server unique references to content received from primary servers; and
notifying a secondary server when content has expired.

52. The method of claim 51 further comprising notifying the secondary server when updated content has been added to the first server.

53. The method of claim 51 further comprising maintaining an index containing the unique references to the content.

54. The method of claim 51 wherein the unique references refer to local content.

55. The method of claim 51 wherein the unique references refer to pointers to content.

56. The method of claim 51 further including passing one of the unique references to the secondary server for use in fetching the content.

57. The method of claim 56 wherein the secondary server manages its cache size in relationship to fetched content or metadata.

58. The method of claim 57 further comprising:
fetching the content in the secondary server; and
checking a size of the fetched content with a size of the cache containing current content in the secondary server.

59. The method of claim 56 wherein the secondary server manages its cache size in relationship to previously fetched content or metadata.

60. The method of claim 56 wherein passing further comprises copying content identified by the unique reference to the secondary server.

61. The method of claim 60 further comprising checking the secondary server to determine whether the content is already present.

62. The method of claim 60 wherein passing further comprises copying metadata associated with the content identified by the unique reference to the secondary server.

63. The method of claim 60 further comprising delivering the copied content to a user system.

64. The method of claim 51 further comprising receiving a user request and effecting a delivering in response to the user request.

65. The method of claim 56 wherein passing further comprises verifying that the secondary server is authorized to receive content.

66. The method of claim 56 wherein passing further comprises updating a tracking file that reflects a user request for content.

67. The method of claim 56 wherein the passing further comprises updating a tracking file that reflects maintaining and notifying.

68. The method of claim 53 wherein the secondary server maintains the index.

69. The method of claim 68 wherein the secondary server notifies a tertiary server when content expires.

70. The method of claim 69 wherein the secondary server passes one of the unique references to the tertiary server.

71. The method of claim 70 wherein the secondary server verifies that the tertiary server is authorized to receive content.

72. The method of claim 70 wherein the secondary server maintains and updates a tracking file that reflects actions performed with the index.
